(19) United States
(12) Patent Application Publication
(10) Pub. No.: US 2016/0042327 A1
(43) Pub. Date: Feb. 11, 2016

(54) METHOD AND SYSTEM FOR PROCESSING OF BUSINESS-TO-BUSINESS PAYMENT TRANSACTIONS

(71) Applicant: MasterCard International Incorporated, Purchase, NY (US)

(72) Inventors: Davide MESSINA, Rome (IT); Vincent LAPRAS, Chatou (FR)

(73) Assignee: MASTERCARD INTERNATIONAL INCORPORATED, Purchase, NY (US)

(21) Appl. No.: 14/451,818

(22) Filed: Aug. 5, 2014

(51) Int. Cl. G06Q 20/10

(52) U.S. Cl. CPC G06Q 20/10

(57) ABSTRACT

A method for processing business-to-business payments includes: storing a plurality of payment rules, each rule including data related to a payment scheme including an institution identifier and payment amount; receiving, from a first financial institution, a notification of payment to be made by a buyer to a seller, the notification including a first institution identifier associated with the first financial institution, a second institution identifier associated with the seller and/or a second financial institution associated with the seller, and a transaction amount; forwarding, to the second financial institution, a payment notification, the notification including the transaction amount and indicates at least one of: the first financial institution, the buyer, and the seller; identifying a specific payment rule where the institution identifier corresponds to the first institution identifier; and processing a payment to the first financial institution based on the payment amount included in the specific payment rule.

### FIELD

The present disclosure relates to the processing of business-to-business payments, specifically the use of a negative payment or rebate to a buyer or issuer to negate the use of interchange fees in business-to-business transactions.

### BACKGROUND

Business-to-business (B2B) transactions often involve the payment of interchange fees from an acquiring bank, associated with a seller of products, to an issuing bank, associated with a buyer of products. Interchange fees collected by issuers can provide motivation for these issuers to encourage buyers to use their payment products, which can lead to new payment products, better incentives for buyers, and other benefits as a result of competition among issuers hoping to earn interchange fees.

However, interchange fees also come at a disadvantage to acquirers and merchants. Interchange fees are often rooted in complex pricing structures that may be difficult for acquirers to understand or implement, specifically for small businesses hoping to honor a wide variety of payment methods in an effort to accommodate as many consumers as possible. In addition, for some merchants and industries interchange fees may exceed profit margins, while in other industries the fees may be greatly exceeded by profit margins.

Thus, the present inventors believe there is a need for a technical solution to provide for an alternative to the use of interchange fees that does not place acquirers at a disadvantage while still incentivizing issuers.

### SUMMARY

The present disclosure provides a description of systems and methods for processing business-to-business payments.

A method for processing business-to-business payments includes: storing, in a rules database, a plurality of payment rules, wherein each payment rule includes data related to a payment scheme including at least an institution identifier and a payment amount; receiving, from a first financial institution, a notification of payment to be made by a buyer to a seller, wherein the notification includes at least a first institution identifier associated with the first financial institution, a second institution identifier, and a transaction amount, the second institution identifier being associated with the seller and/or a second financial institution associated with the seller; forwarding, to the second financial institution, a payment notification, wherein the payment notification includes at least the transaction amount and indicates at least one of: the first financial institution, the buyer, and the seller; identifying, in the rules database, a specific payment rule where the included institution identifier corresponds to the first institution identifier included in the received notification of payment to be made; and processing, by a processing device, a payment to the first financial institution based on the payment amount included in the specific payment rule.

A system for processing business-to-business payments includes a rules database, a receiving device, a transmitting device, and a processing device. The rules database is configured to store a plurality of payment rules, wherein each payment rule includes data related to a payment scheme including at least an institution identifier and a payment amount. The receiving device is configured to receive, from a first financial institution, a notification of payment to be made by a buyer to a seller, wherein the notification includes at least a first institution identifier associated with the first financial institution, a second institution identifier, and a transaction amount, the second institution identifier being associated with the seller and/or a second financial institution associated with the seller. The transmitting device is configured to forward, to the second financial institution, a payment notification, wherein the payment notification includes at least the transaction amount and indicates at least one of: the first financial institution, the buyer, and the seller. The processing device is configured to: identify, in the rules database, a specific payment rule where the included institution identifier corresponds to the first institution identifier included in the received notification of payment to be made; and process a payment to the first financial institution based on the payment amount included in the specific payment rule.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for processing business-to-business payments in accordance with exemplary embodiments.

FIG. 2 is a block diagram illustrating the processing server of FIG. 1 for the processing of business-to-business payments in accordance with exemplary embodiments.

FIG. 3 is a flow diagram illustrating a method for processing business-to-business payments in a system including an issuer and acquirer in accordance with exemplary embodiments.

FIG. 4 is a flow diagram illustrating a method for processing business-to-business payments in a system including a single financial institution operating as issuer and acquirer in accordance with exemplary embodiments.

FIG. 5 is a flow diagram illustrating a method for processing business-to-business payments using the processing server of FIG. 2 in accordance with exemplary embodiments.

FIG. 6 is a flow chart illustrating an exemplary method for processing business-to-business payments in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

### System for Processing Business-to-Business Payments

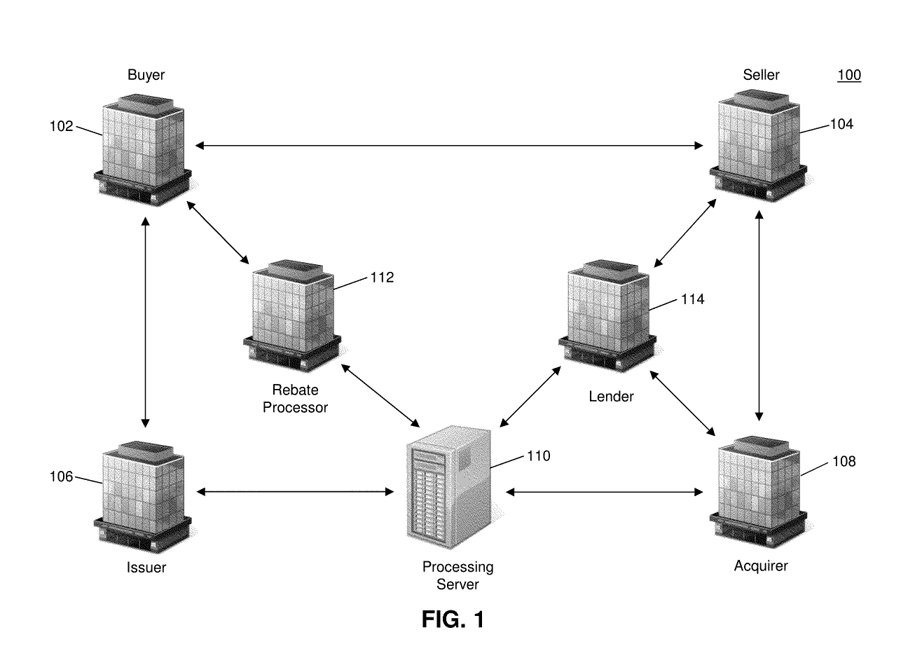

FIG. 1 illustrates a system 100 for the processing of business-to-business (B2B) payments without the payment of an interchange fee between an acquirer and issuer. The system 100 may include a buyer 102. The buyer 102 may arrange to buy products (e.g., goods or services) available for purchase from a seller 104. The buyer 102 and seller 104 may agree on terms for the transaction, such as a transaction amount. In some instances, the seller 104 may agree to provide the purchased products prior to receipt of payment, such as by allowing the buyer 102 a 30- or 90-day pay period.

Once the buyer 102 and seller 104 have agreed on terms for the transaction, the transaction may be initiated. An issuer 106, which may be an issuing bank or other financial institution that has one or more payment accounts associated with the buyer 102, may receive notice regarding the payment transaction, such as from the buyer 102 or seller 104. The issuer 106 may ensure that the buyer 102 is approved for the transaction, such as based on terms and conditions of account(s) associated with the buyer 102, and then transmit a notification of payment to be forwarded to an acquirer 108. The acquirer 108 may be an acquiring bank or other financial institution that has one or more payment account associated with the seller 104.

The notification may first be transmitted to a processing server 110. The processing server 110, discussed in more detail below, may be configured to process the notification of payment by providing a negative payment or rebate back to the issuer 106 and forwarding the notification of payment to the acquirer 108. As discussed in more detail below, the negative payment or rebate provided to the issuer 106 may be based on the issuer 106, transaction data for the payment transaction, such as the transaction amount, the acquirer 108, the seller 104, or suitable other considerations as will be apparent to persons having skill in the relevant art. In some embodiments, a rebate may also be provided to the buyer 102. In such an embodiment, the rebate may be processed via a rebate processor 112.

The processing server 110 may forward a payment notification to the acquirer 108 regarding the payment to be made from the buyer 102 to the seller 104. The payment notification may indicate the payment amount and the seller 104 to receive the amount, and may also indicate the buyer 102 and/or issuer 106 or any other suitable data, such as an invoice number, purchase order number, etc. The acquirer 108 may receive the payment notification and provide payment to the seller 104 accordingly. As will be apparent to persons having skill in the relevant art, in some instances the acquirer 108 may not provide payment to the seller 104 until payment has been received from the issuer 106 (e.g., prior to expiration of an established waiting period).

In some embodiments, the processing server 110 may be configured to provide an estimated negative payment and/or rebate amount. In such an embodiment, the buyer 102 and/or issuer 106 may provide the processing server 110 with information regarding a potential payment to be made to the acquirer 108 and/or seller 104, such as using the methods and systems discussed herein. The processing server 110 may then identify an estimated negative payment amount to be paid to the issuer 106 and/or an estimated rebate amount to be paid to the buyer 102 (e.g., via the issuer 106) based on the supplied information. The processing server 110 may then provide the estimated information to the issuer 106 and/or buyer 102, such as for use in a determination to proceed with a purchase.

In some instances, the seller 104 may desire immediate payment rather than wait until the end of a 30- or 90-day waiting period. In such an instance, the processing server 110 may identify a lender 114 that may be willing to provide immediate payment to the seller 104 in exchange for a fee or other consideration. The lender 114 may provide details to the processing server 110, seller 104, and/or acquirer 108 of an amount to be provided to the seller 104, which may be discounted from the payment amount agreed to be paid to the seller 104 by the buyer 102 for services rendered. The processing server 110 may facilitate the lending of the amount from the lender 114 to the seller 104 by including information regarding the lending to the acquirer 108 in the payment notification.

In some embodiments, the processing server 110 may also be configured to process the payment transaction between the issuer 106 and the acquirer 108 (e.g., or the lender 114) for the payment transaction. In such an embodiment, the processing server 110 may operate as, or be a part of, a payment network. Methods and systems for the processing of payment transactions by a payment network will be apparent to persons having skill in the relevant art.

In some embodiments, as discussed in more detail below, the issuer 106 and acquirer 108 may be a single financial institution associated with both the buyer 102 and the seller 104. In further embodiments, the processing server 110 may be a part of the single financial institution. In such an embodiment, the negative payment or rebate may be provided to the buyer 102 or may be accorded to the benefit of the buyer 102 or other buyers, such as for use in providing payment products to consumers of the financial institution.

The use of a negative payment or rebate to the issuer 106 rather than an interchange fee provided by the acquirer 108 to the issuer 106 may provide the same incentive to the issuer 106 to develop products and features to benefit the buyer 102, while at the same time saving the acquirer 108 from having to deal with difficult and costly fees. In addition, by operating as a payment processor, the processing server 110 may be able to provide for additional beneficial services to the buyer 102 and seller 104 in such a transaction, such as by providing rebates to the buyer 102 or arranging for advanced payment to the seller 104.

### Processing Server

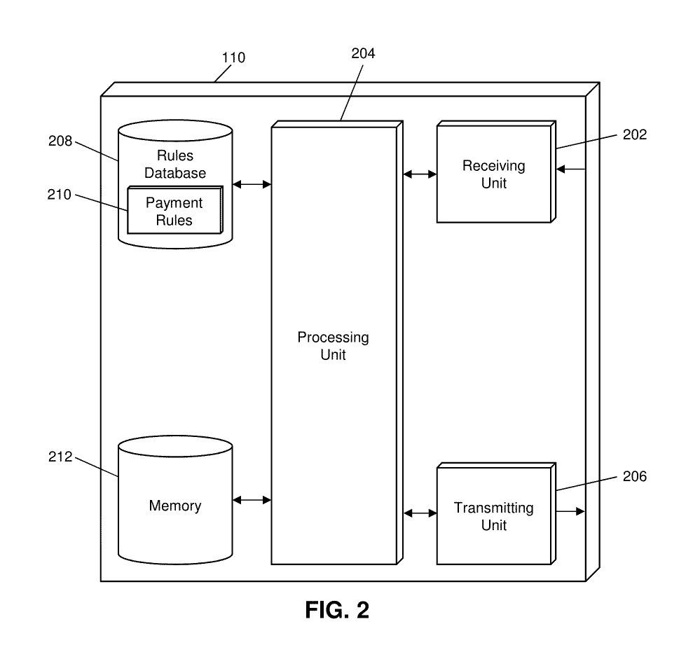

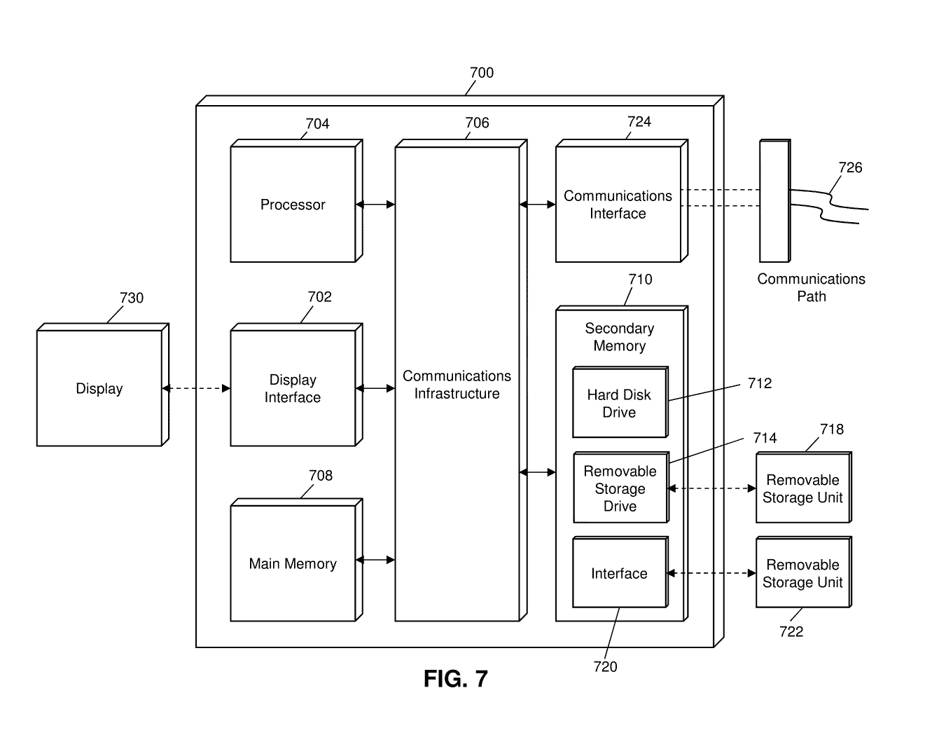

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of processing server 110 suitable for performing the functions as discussed herein. For example, the computer system 700 illustrated in FIG. 7 and discussed in more detail below may be a suitable configuration of the processing server 110.

The processing server 110 may include a receiving unit 202. The receiving unit 202 may be configured to receive data over one or more networks via one or more network protocols. The receiving unit 202 may receive a notification of payment from the issuer 106 including a first institution identifier associated with the issuer 106, a second institution identifier associated with the acquirer 108, and a transaction amount. The notification of payment may correspond to a payment transaction for the purchase of goods or services by the buyer 102 from the seller 104.

The processing server 110 may also include a processing unit 204. The processing unit 204 may be configured to identify a payment amount for a negative payment or rebate to be paid to the issuer 106 corresponding to the payment transaction. The payment amount may be based on a payment rule 210 associated with the issuer 106 and stored in a rules database 208 of the processing server 110. Each payment rule 210 may include an institution identifier associated with a financial institution (e.g., the issuer 106) and a payment amount. The payment amount may be a value corresponding to the payment to be paid to the associated financial institution, or may be a value that may be applied to additional data, such as the transaction amount, for calculation of an amount to be paid to the associated financial institution.

The processing unit 204 may identify the payment rule 210 associated with the issuer 106 based on the included institution identifier and the first institution identifier included in the received notification of payment. The processing unit 204 may also be configured to then identify the amount to be paid to the issuer 106 based on the included payment amount. The processing unit 204 may be further configured to process a payment to the issuer 106 for the identified amount using methods and systems that will be apparent to persons having skill in the relevant art.

The processing server 110 may also include a transmitting unit 206. The transmitting unit 206 may be configured to transmit data over one or more networks via one or more network protocols. The transmitting unit 206 may be configured to transmit a payment notification to the acquirer 108. The payment notification may be generated by the processing unit 204 and may include the transaction amount and may indicate at least one of: the buyer 102, the issuer 106, and the seller 104. In some embodiments, the processing unit 204 may also identify the lender 114 and a lending amount for inclusion in the payment notification. In such an embodiment, information regarding the lender 114 may be stored in a memory 212 and retrieved by the processing unit 204, or may be requested (e.g., via the transmitting unit 206) from the lender 114 and received (e.g., via the receiving unit 202) for inclusion in the payment notification.

The transmitting unit 206 may also be configured to transmit rebate data to a rebate processor 112 for the processing of a rebate to the buyer 102. The rebate data may include information identifying the buyer 102, such as an account number, identification number, etc., and may also include a rebate amount. The rebate amount may be included in or based on additional data included in the identified payment rule 210 associated with the issuer 106.

### Processes for Processing Business-to-Business Payments

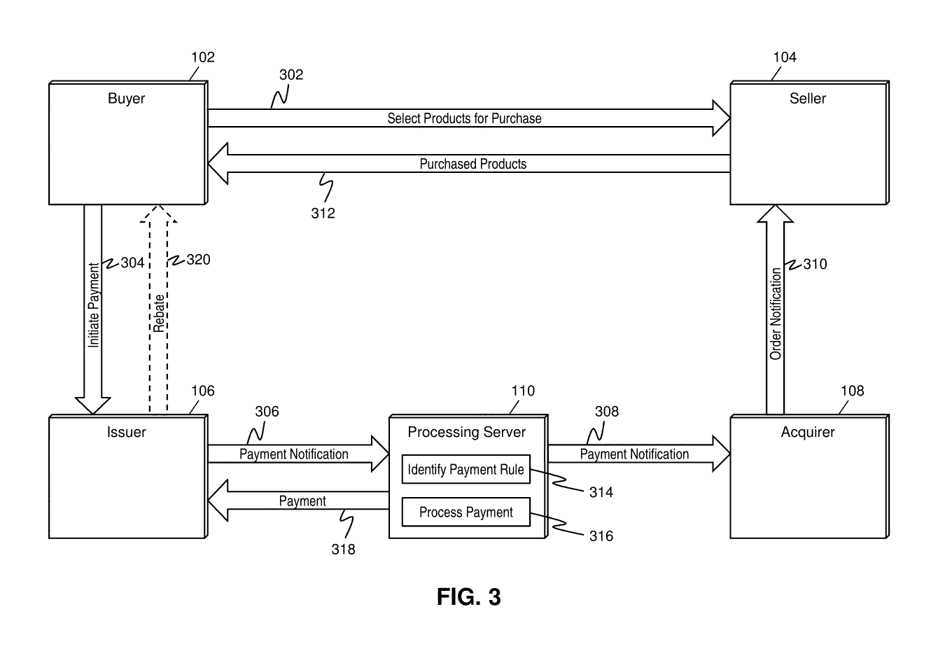

FIG. 3 illustrates a process for the processing of B2B payments without the use of an interchange fee and including a negative payment or rebate to the issuer 106.

In step 302, the buyer 102 may select products for purchase from the seller 104 and negotiate with the seller 104 regarding a transaction for the selected products. Once the buyer 102 and seller 104 have agreed on the purchase, then, in step 304, the buyer 102 may initiate the payment process with their issuer 106, such as by indicating the purchase amount and any other additional data (e.g., invoice number, purchase order number, etc.). In some embodiments, the payment initiation may be provided by the seller 104.

In step 306, the issuer 106 may provide a payment notification to the processing server 110. The payment notification may include at least the transaction amount, a first institution identifier associated with the issuer 106, and a second institution identifier associated with the acquirer 108 or the seller 104. The processing server 110 may receive (e.g., via the receiving unit 202) and forward (e.g., via the transmitting unit 206) the payment notification or data included therein to the acquirer 108. The acquirer 108 may, in step 310, provide an order notification to the seller 104 to indicate that the payment notification has been received, which may provide assurance to the seller 104 (e.g., in instances where there is a delayed period for payment) that future payment is arranged. In step 312, the seller 104 may provide the transacted-for products to the buyer 102.

In step 314, the processing unit 204 of the processing server 110 may identify a payment rule 210 associated with the issuer 106 where the included institution identifier corresponds to the first institution identifier received in the payment notification. In step 316, the processing unit 204 may process payment to the issuer 106 based on the payment amount included in the identified payment rule 210. In some instances, the payment amount may be further based on the transaction amount included in the received payment notification. In step 318, the issuer 106 may receive the payment.

In step 320, the issuer 106 may provide a rebate to the buyer 102 based on the received payment from the processing server 110. In some embodiments, the rebate may be provided directly from the processing server 110 to the buyer 102. It will be apparent to persons having skill in the relevant art that step 320 is an optional step, and that, in some instances, the buyer 102 may not receive a rebate for the payment transaction.

In some embodiments, step 312, where the seller 104 may provide the transacted-for products to the buyer 102, may take place after step 302 and before step 304. In such an embodiment, the initiation of the payment to the issuer 106, step 304, may occur as a result of the receipt of the products by the buyer 102. In some instances, the initiation of the payment by the buyer 102 in step 304 may be provided to the processing server 110. In such an instance, step 306 may include the transmitting of the payment notification from the processing server 110 to the issuer 106, such as to indicate to the issuer 106 that the buyer 102 has initiated payment to the seller 104. In one embodiment, the initiation of the payment by the buyer 102 to the processing server 110 may occur after receipt of the purchased products by the buyer 102.

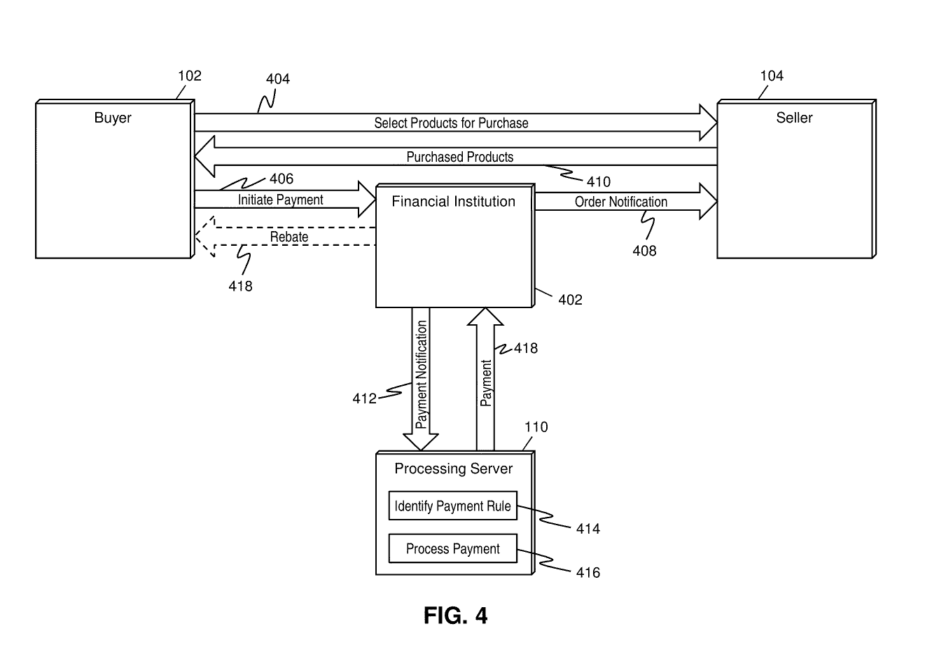

FIG. 4 illustrates an alternative process for the processing of B2B transactions where the system 100 includes a single financial institution 402 operating as both the issuer 106 and the acquirer 108.

In step 404, the buyer 102 may select products for purchase from the seller 104. In step 406, the buyer 102 may initiate payment with the financial institution 402 for payment to the seller 104 for the transacted-for products. In step 408, the financial institution may notify the seller 104 of the order. In step 410, the seller may provide the purchased products to the buyer 102. In some embodiments, step 410, where the seller 104 may provide the transacted-for products to the buyer 102, may take place after step 404 and before step 406. In such an embodiment, the initiation of the payment to the financial institution 402, step 406, may occur as a result of the receipt of the products by the buyer 102.

In step 412, the financial institution 402 may provide a payment notification to the processing server 110 including an institution identifier associated with the financial institution 402 and the transaction amount. In step 414, the processing server 110 may identify a payment rule 210 associated with the financial institution 402 including the institution identifier included in the payment notification. Then, in step 416, the processing server 110 may process payment based on the payment amount included in the identified payment rule 210 to the financial institution 402. In optional step 418, the financial institution 402 may provide a rebate to the buyer 102.

### Process for Identifying and Processing a Negative Payment or Rebate

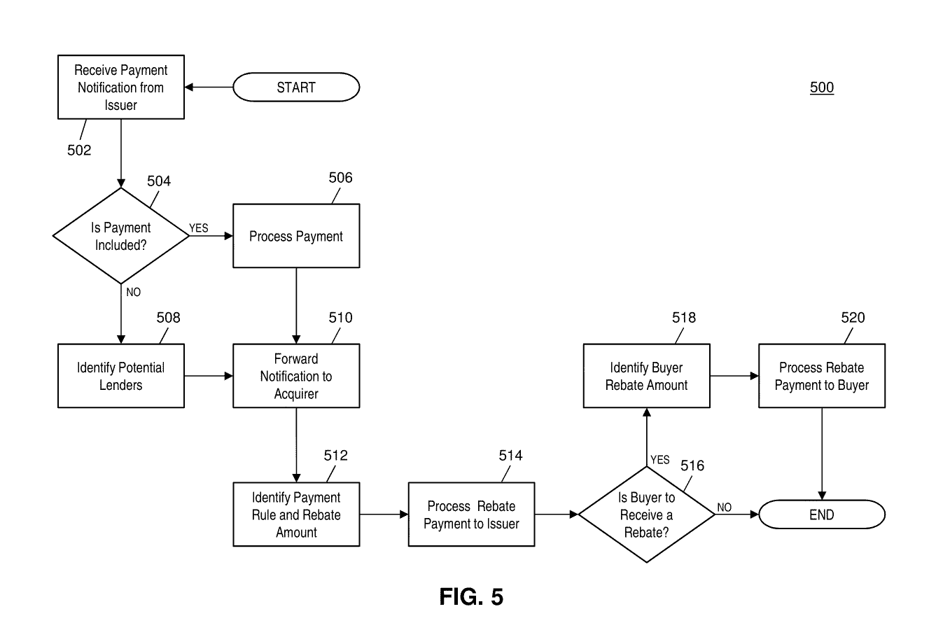

FIG. 5 illustrates a process 500 for the identification and processing of a negative payment or rebate to the issuer 106 by the processing server 110 in a B2B payment transaction.

In step 502, the receiving unit 202 of the processing server 110 may receive a payment notification from the issuer 106. The payment notification may include at least a transaction amount, an identifier associated with the issuer 106, and an identifier associated with the seller 104 and/or the acquirer 108. In step 504, the processing unit 204 of the processing server 110 may identify if the payment notification is accompanied by payment to be processed and provided to the acquirer 108 and/or seller 104. If payment is provided, then, in step 506, the processing unit 204 may process the payment to the acquirer 108 using methods and systems that will be apparent to persons having skill in the relevant art.

If no payment is provided (e.g., the buyer 102 has a period of time to provide payment), then, in step 508, the processing unit 204 may identify potential lenders 114 that may be willing to provide early payment to the seller 104 in exchange for a fee or service. The processing unit 204 may identify information regarding the potential lenders 114 and/or an early payment amount or feed to be paid as a result of using the services. Once payment has been processed or lenders 114 identified, then, in step 510, the payment notification or data included therein may be forwarded, via the transmitting unit 206 of the processing server 110, to the acquirer 108. The forwarded data may include the transaction amount and identify at least one of: the issuer 106, the buyer 102, and the seller 104. The forwarded data may also include an indication of processed payment or the identified potential lenders 114 and associated data.

In step 512, the processing unit 204 may identify a payment rule 210 stored in the rules database 208 where the included institution identifier corresponds to the identifier included in the received payment notification that is associated with the issuer 106. The processing unit 204 may further identify a rebate or negative payment amount to be paid to the issuer 106 based on at least the payment amount included in the identified payment rule 210. In some embodiments, the rebate or negative payment amount may be further based on the transaction amount included in the received payment notification.

In step 514, the processing unit 204 may process the rebate or negative payment to the issuer 106, for the identified payment amount, using methods and systems that will be apparent to persons having skill in the relevant art. In step 516, the processing unit 204 may identify if the buyer 102 is also to receive a rebate. The determination may be based on data included in the payment rule 210, received in the payment notification, or any other suitable source that will be apparent to persons having skill in the relevant art. If the buyer 102 is not to receive a rebate, then the process 500 may be completed.

If the buyer 102 is to receive a rebate, then, in step 518, the processing unit 204 may identify the rebate amount to be provided to the buyer 102. The rebate amount may be identified in the data used in step 516, such as by being included in or based on data included in the payment rule 210. In step 520, the processing unit 204 may process the rebate payment to the buyer 102 for the rebate amount.

### Exemplary Method for Processing Business-to-Business Payments

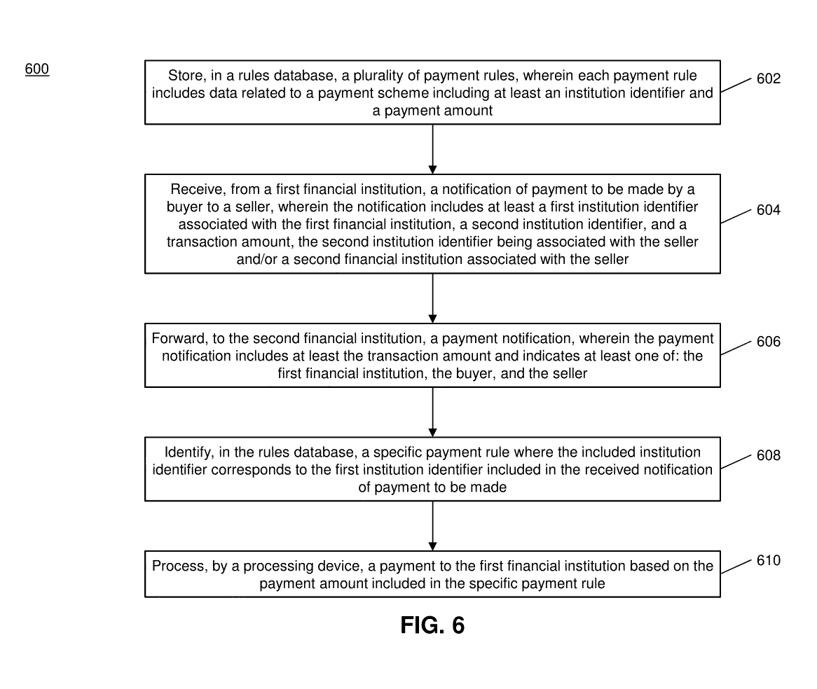

FIG. 6 illustrates a method 600 for the processing of business-to-business payments including a negative payment or rebate made to a first financial institution involved in a payment transaction.

In step 602, a plurality of payment rules (e.g., payment rules 210) may be stored in a rules database (e.g., the rules database 208), wherein each payment rule 210 includes data related to a payment scheme including at least an institution identifier and a payment amount.

In step 604, a notification of payment to be made by a buyer (e.g., the buyer 102) to a seller (e.g., the seller 104) may be received from a first financial institution (e.g., the issuer 106), wherein the notification includes at least a first institution identifier associated with the first financial institution, a second institution identifier, and a transaction amount, the second institution identifier being associated with the seller 104 and/or a second financial institution (e.g., the acquirer 108) associated with the seller 104. In one embodiment, the first financial institution may be an issuing bank associated with the buyer 102 and the second financial institution may be an acquiring bank associated with the seller 104. In some embodiments, the first financial institution and the second financial institution may be a single financial institution.

In step 606, a payment notification may be forwarded (e.g., via the transmitting unit 206) to the second financial institution, wherein the payment notification includes at least the transaction amount and indicates at least one of: the first financial institution, the buyer 102, and the seller 104. In step 608, a specific payment rule 210 may be identified, in the rules database 208, where the included institution identifier corresponds to the first institution identifier included in the received notification of payment to be made.

In step 610, a payment may be processed, by a processing device (e.g., the processing unit 204), to the first financial institution based on the payment amount included in the specific payment rule 210. In one embodiment, the processed payment may be in the form of a rebate paid to the first financial institution. In some embodiments, the payment processed to the first financial institution may be further based on an application of the payment amount to the transaction amount included in the received notification of payment to be made. In some embodiments, the method 600 may further include processed, by the processing device 204, a rebate to the buyer 102 based on the payment amount included in the specific payment rule 210.

In one embodiment, the method 600 may further include processing, by the processing device 204, a payment transaction for the transaction amount from the first financial institution to the second financial institution. In a further embodiment, the processed payment transaction may be for less than the transaction amount if processed within a predetermined period of time. In an event further embodiment, the predetermined period of time may be based on at least one of: the second financial institution and the supplier 104.

In some embodiments, the method 600 may further include identifying, by the processing device 204, a third financial institution (e.g., the lender 114) configured to lend a lending amount to the seller 104, wherein the lending amount is based on the payment amount and the forwarded payment notification further includes the identified third financial institution. In further embodiments, the method 600 may even further include processing, by the processing device 204, a payment transaction for the transaction amount from the first financial institution to the third financial institution.

### Computer System Architecture

FIG. 7 illustrates a computer system 700 in which embodiments of the present disclosure, or portions thereof, may be implemented as computer-readable code. For example, the processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-5, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for processing business-to-business payments. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing business-to-business payments, comprising:
storing, in a rules database, a plurality of payment rules, wherein each payment rule includes data related to a payment scheme including at least an institution identifier and a payment amount;
receiving, from a first financial institution, a notification of payment to be made by a buyer to a seller, wherein the notification includes at least a first institution identifier associated with the first financial institution, a second institution identifier, and a transaction amount, the second institution identifier being associated with the seller and/or a second financial institution associated with the seller;
forwarding, to the second financial institution, a payment notification, wherein the payment notification includes at least the transaction amount and indicates at least one of: the first financial institution, the buyer, and the seller;
identifying, in the rules database, a specific payment rule where the included institution identifier corresponds to the first institution identifier included in the received notification of payment to be made; and
processing, by a processing device, a payment to the first financial institution based on the payment amount included in the specific payment rule.

2. The method of claim 1, further comprising:
processing, by the processing device, a payment transaction for the transaction amount from the first financial institution to the second financial institution.

3. The method of claim 2, wherein the processed payment transaction is for less than the transaction amount if processed within a predetermined period of time.

4. The method of claim 3, wherein the predetermined period of time is based on at least one of: the second financial institution and the supplier.

5. The method of claim 1, wherein the processed payment is in the form of a rebate to the first financial institution.

6. The method of claim 1, further comprising:
processing, by the processing device, a rebate to the buyer based on the payment amount included in the specific payment rule.

7. The method of claim 1, wherein the payment processed to the first financial institution is further based on an application of the payment amount to the transaction amount included in the received notification of payment to be made.

8. The method of claim 1, wherein the first financial institution is an issuing bank associated with the buyer and the second financial institution is an acquiring bank associated with the seller.

9. The method of claim 1, further comprising:
identifying, by the processing device, a third financial institution configured to lend a lending amount to the seller, wherein
the lending amount is based on the payment amount, and
the forwarded payment notification further includes the identified third financial institution.

10. The method of claim 9, further comprising:
processing, by the processing device, a payment transaction for the transaction amount from the first financial institution to the third financial institution.

11. The method of claim 1, wherein the first financial institution and second financial institution are a single financial institution.

12. A system for processing business-to-business payments, comprising:
a rules database configured to store a plurality of payment rules, wherein each payment rule includes data related to a payment scheme including at least an institution identifier and a payment amount;
a receiving device configured to receive, from a first financial institution, a notification of payment to be made by a buyer to a seller, wherein the notification includes at least a first institution identifier associated with the first financial institution, a second institution identifier, and a transaction amount, the second institution identifier being associated with the seller and/or a second financial institution associated with the seller;
a transmitting device configured to forward, to the second financial institution, a payment notification, wherein the payment notification includes at least the transaction amount and indicates at least one of: the first financial institution, the buyer, and the seller; and
a processing device configured to
identify, in the rules database, a specific payment rule where the included institution identifier corresponds to the first institution identifier included in the received notification of payment to be made, and
process a payment to the first financial institution based on the payment amount included in the specific payment rule.

13. The system of claim 12, wherein the processing device is further configured to process a payment transaction for the transaction amount from the first financial institution to the second financial institution.

14. The system of claim 13, wherein the processed payment transaction is for less than the transaction amount if processed within a predetermined period of time.

15. The system of claim 14, wherein the predetermined period of time is based on at least one of: the second financial institution and the supplier.

16. The system of claim 12, wherein the processed payment is in the form of a rebate to the first financial institution.

17. The system of claim 12, wherein the processing device is further configured to process a rebate to the buyer based on the payment amount included in the specific payment rule.

18. The system of claim 12, wherein the payment processed to the first financial institution is further based on an application of the payment amount to the transaction amount included in the received notification of payment to be made.

19. The system of claim 12, wherein the first financial institution is an issuing bank associated with the buyer and the second financial institution is an acquiring bank associated with the seller.

20. The system of claim 12, wherein
the processing device is further configured to identify a third financial institution configured to lend a lending amount to the seller,
the lending amount is based on the payment amount, and
the forwarded payment notification further includes the identified third financial institution.

21. The system of claim 20, wherein the processing device is further configured to process a payment transaction for the transaction amount from the first financial institution to the third financial institution.

22. The system of claim 12, wherein the first financial institution and second financial institution are a single financial institution.
